(19) United States
(12) Patent Application Publication
(10) Pub. No.: US 2024/0164251 A1
(43) Pub. Date: May 23, 2024

(54) MOWER KNIFE DEVICE

(71) Applicant: Wepfer Technics AG, Andelfingen (CH)

(72) Inventor: Hans WEPFER, Berg Dägerlen (CH)

(21) Appl. No.: 18/524,324

(22) Filed: Nov. 30, 2023

(30) Foreign Application Priority Data
Nov. 22, 2022 (EP) 22 210 607.2

(51) Int. Cl. A01D 34/14; A01D 34/135

(52) U.S. Cl. CPC A01D 34/14; A01D 34/135; A01D 2101/00

(57) ABSTRACT

The invention relates to a mower knife device (100) with (i) a double-knife cutting system (111), wherein the double-knife cutting system (111) comprises an upper cutting knife (140) and a lower cutting knife (180), which are configured to be movable in translation relatively to one another, wherein the upper cutting knife (140) and the lower cutting knife (180) each comprise a plurality of blade elements (145) and a knife back (144, 184), wherein the blade elements (145) are connected to each other via the knife back (144, 183) and are arranged substantially in a knife plane (150), and (ii) a knife bar (110) which comprises a first extension (112) in the direction of an axis (170) orthogonal to the knife plane (150) and which is configured to hold the double-knife cutting system (111), wherein a gap (160) is arranged between the knife bar (110) and the double-knife cutting system (111), wherein a section of the knife back (144, 184) adjoins the gap (160), wherein the section of the knife back (144, 184) adjoining the gap (160) is bent in the direction of the orthogonal axis (170).

### TECHNICAL FIELD

The invention relates to a mower knife device with a double-knife cutting system, wherein the double-knife cutting system comprises an upper cutting knife and a lower cutting knife.

### STATE OF THE ART

The publication EP3881663B1 relates to a mower knife device with a double-knife cutting system with an upper and a lower cutting knife, each comprising a plurality of approximately triangular blade elements. The blade elements of the upper cutting knife and the lower cutting knife are each integrally connected to one another via a knife back. The two knife backs are separated by a gap from a knife bar, which is connected to the double-knife cutting system by means of holding devices. Both the upper cutting knife and the lower cutting knife are flat. To stabilize the double-knife cutting system, additional reinforcements are attached to the cutting knives, for example in the connection area with a knife head, which directs a force provided by a lateral drive to the upper cutting knife in order to move the cutting knives relative to each other.

A disadvantage of the mower knife device known in the prior art is that clippings can get caught and stuck in the gap between the double-knife cutting system and the knife bar, which usually shortens the service life of the mower knife device. Another disadvantage in the prior art is that clippings can also get stuck on the additional reinforcements; furthermore, these lead to an overall heavier structure of this known mower knife device, resulting in an increased power requirement. An additional disadvantage in the prior art is that the approximately triangular blade elements cause clippings to be cut partially at an angle, which in turn can cause an increased amount of clippings to adhere to the mower knife device.

### DESCRIPTION OF THE INVENTION

The task of the invention is to provide a mower knife device which eliminates at least some of the disadvantages of the mower knife device known from the prior art.

The solution to the problem is defined by the features of claim 1. The invention relates to a mower knife device with (i) a double-knife cutting system, wherein the double-knife cutting system comprises an upper cutting knife and a lower cutting knife, which are configured to be movable in translation relative to one another, wherein the upper cutting knife and the lower cutting knife each comprise a plurality of blade elements and a knife back, wherein the blade elements are configured to be connected to one another via the knife back and are arranged substantially in a knife plane, and (ii) a knife bar which comprises a first extension in the direction of an axis orthogonal to the knife plane and which is configured to hold the double-knife cutting system, wherein a gap is arranged between the knife bar and the double-knife cutting system, wherein a section of the knife back is adjacent to the gap, wherein the section of the knife back adjacent to the gap is bent in the direction of the orthogonal axis.

Bending the section of the knife back of the upper cutting knife and the knife back of the lower cutting knife adjacent to the gap improves the stability of the two cutting knives. The bending of the two cutting knives according to the invention means that no additional reinforcements to which cuttings can adhere are required to stabilize the double-knife cutting system, as the bending strength of the two cutting knives is improved. The bent sections of the knife back of the upper and lower cutting knives adjacent to the gap in the direction of the orthogonal axis further shield the gap between the knife bar and the double-knife cutting system in such a way that less clippings, which move from the blade elements towards the knife bar when the mower knife device according to the invention is used, enter the gap and get stuck there. The mower knife device according to the invention thus comprises fewer components compared to mower knife devices known from the prior art and at the same time reduces the amount of clippings that get stuck, which increases the service life of the mower knife device according to the invention compared to prior art mower knife devices.

The knife plane extends between the upper cutting knife and the lower cutting knife and touches at least the blade elements of the two cutting knives, i.e. the blade elements of the two cutting knives are directly adjacent to the knife plane. The blade elements are flat at least on an underside in the case of the upper cutting knife and on an upper side in the case of the lower cutting knife, wherein the underside and upper side of the blade elements are in contact when the mower knife device according to the invention is used. The knife plane is therefore in flat contact with the blade elements.

In one embodiment of the mower knife device according to the invention, the knife bar is arranged at the level of the double-knife cutting system, in particular symmetrically about the knife plane, and/or the section of the knife back of the upper cutting knife adjacent to the gap and the section of the knife back of the lower cutting knife adjacent to the gap are bent substantially symmetrically with respect to the knife plane.

Positioning the knife bar at the level of the double-knife cutting system enables good shielding of the gap between the knife bar and the double-knife cutting system by the bent sections of the two cutting knives. Preferably, the sections of the knife back of the lower cutting knife and the upper cutting knife are bent symmetrically with respect to the knife plane: the section of the knife back of the upper cutting knife bordering the gap is in particular bent upwards, i.e. away from the knife plane, and the section of the knife back of the lower cutting knife bordering the gap is in particular bent downwards, i.e. also away from the knife plane.

In a further embodiment of the mower knife device according to the invention, the section of the knife back adjacent to the gap is bent along an entire width of the double-knife cutting system, in particular uniformly.

The term width refers to an extension of the double-knife cutting system in a direction running along the gap. The section of the knife back adjacent to the gap may preferably be bent along this entire width, which may further improve the stability of the cutting knife. In particular, the type and extent of the bend can be uniform, i.e. equally pronounced, along the entire width: this can prevent the occurrence of local weak points, which can arise, for example, due to insufficient local bending. Furthermore, a uniformly bent section of the knife back can also be manufactured more easily.

In a further embodiment of the mower knife device according to the invention, the section of the knife back adjacent to the gap is bent such that a distance between a projecting part of the bent knife back of the upper cutting knife and a projecting part of the bent knife back of the lower cutting knife in the direction of the orthogonal axis corresponds to at least the first extension of the knife bar.

The knife back can be bent in such a way that the part of the knife bar adjacent to the gap, looking from the blade elements in the direction of the knife bar at knife plane level, is completely covered by the bent sections of the knife back of the two cutting knives. The bent knife backs can have a spoiler-like effect, as clippings are deflected upwards in the case of the upper cutting knife and downwards in the case of the lower cutting knife and are located above or below the knife bar after leaving the bent sections of the knife back, which means that less clippings get into the gap between the double-knife cutting system and the knife bar and get stuck there.

In a further embodiment of the mower knife device according to the invention, the bent section of the knife back is flat and comprises a bending angle of between 5° and 45°, preferably 15°, relative to the knife plane.

Different bending processes can be used to produce the bent knife back, i.e. both bending forming with straight tool movement and bending forming with rotating tool movement. The bending angle or bending radius can be adapted to an extension of the gap between the double-knife cutting system and the knife bar and/or to the first extension of the knife bar.

In a further embodiment of the mower knife device according to the invention, each blade element comprises two boundaries configured in a strictly convex manner with cutting edges arranged thereon, wherein the cutting edge of one blade element and the opposite cutting edge of an adjacent blade element extend continuously across the knife back.

Since the blade elements are configured to be essentially flat, their lateral boundaries can be regarded as one-dimensional lines in a two-dimensional plane when viewed from above the blade element. Two, in particular lateral, boundaries of the blade elements can be configured as strictly convex, whereby the term strictly convex means that a connecting line between any two points of the respective strictly convex boundary lies completely above this strictly convex boundary. Cutting edges are arranged on these two strictly convex configured boundaries. The cutting edge of a blade element can be connected to the opposite cutting edge of an adjacent blade element and extend continuously over the knife back: this can reduce a contact surface on which cuttings can adhere.

In a further embodiment of the mower knife device according to the invention, each blade element is symmetrically constructed around a centerline which runs parallel to a direction from a blade tip of the blade element to the knife bar, wherein the two strictly convex configured boundaries in the area of the blade tip run essentially parallel to the centerline.

In the vicinity of the blade tip, which may be flattened, the two strictly convexly configured boundaries may be substantially parallel to the centerline, which may represent an axis of symmetry for the blade element. In the vicinity of a point of contact between a strictly convex boundary of a blade element and an opposite strictly convex boundary of an adjacent blade element, the strictly convex boundary and the opposite strictly convex boundary may be substantially orthogonal to the centerline. The centerlines of different blade elements can run parallel to each other. A blade element of the upper cutting knife and a blade element of the lower cutting knife can then form a small cutting angle if the distance between their respective centerlines is sufficiently small. Advantageously, this ensures that clippings are cut in an upright position and thus cling less to the mower knife device. This also favors the effect of the spoiler-like curved cutting knives, as clippings are deflected upwards in the case of the upper cutting knife and downwards in the case of the lower cutting knife and are located above or below the knife bar after leaving the bent sections of the knife back. The more upright the clippings are cut, the better they can be deflected, which means that less clippings get into the gap between the double-knife cutting system and the knife bar and get stuck there.

In a further embodiment of the mower knife device according to the invention, the cutting edges are configured to be flat. The cutting edges can be configured to be flat and comprise a linear ascending or descending profile.

In a further embodiment of the mower knife device according to the invention, the distance between the projecting part of the knife back of the upper cutting knife and the projecting part of the knife back of the lower cutting knife is greater than the first extension by at least 5 mm, preferably 15 mm, in each case.

In a further embodiment of the mower knife device according to the invention, the mower knife device comprises a knife head for initiating a drive movement of a lateral drive on the double-knife cutting system, wherein the knife head is fixedly connected directly to the upper cutting knife at a remaining section of the knife back which comprises sections of the knife back lying outside the bent section, and in particular is fixedly connected without additional reinforcement.

The bent knife back according to the invention means that additional reinforcement at a connection point of the knife head to the upper cutting knife is not required, as the bent knife back according to the invention leads to increased stability. The knife head can be attached to the knife back outside the bent section of the knife back.

The knife head for initiating a drive movement of a lateral drive on the double-knife cutting system can alternatively also be attached directly, i.e. without additional reinforcements, to the bent section of the knife back of the upper cutting knife.

In a further embodiment of the mower knife device according to the invention, the knife back comprises an extension of at least 10 mm, preferably 33 mm, in the direction from a blade tip of the blade element to the knife bar, wherein the bent section of the knife back comprises an extension of at least 5 mm, preferably half of the extension of the knife back, in the direction from a blade tip of the blade element to the knife bar.

The bent section of the knife back reduces the contact surface between the upper cutting knife and the lower cutting knife on the knife back. This increases the contact pressure between the upper cutting knife and the lower cutting knife in the area of the remaining contact surface of the knife back. This has additional advantages: the increased contact pressure means that less clippings and dirt can get between the upper cutting knife and the lower cutting knife, which can increase the service life of the mower knife device. If clippings and dirt do get between the upper cutting knife and the lower cutting knife, they are removed more quickly in the direction of the knife bar due to the reduced depth caused by the bent sections of the knife back.

In a further embodiment of the mower knife device according to the invention, the upper cutting knife and/or the lower cutting knife is configured in one piece, in particular made from a flat steel and then bent. For example, the upper cutting knife and/or the lower cutting knife is configured in one piece, in particular manufactured from a flat steel and then bent, at least 1 m and at most

6 m wide. The term width refers to an extension of the double-knife cutting system in a direction that runs along the gap.

In a further embodiment of the mower knife device according to the invention, the remaining sections of the upper cutting knife and the lower cutting knife are configured to be substantially flat outside the bent sections of the knife back.

In a further embodiment of the mower knife device according to the invention, no further additional reinforcements are provided on the upper cutting knife and/or on the lower cutting knife.

Further advantageous embodiments and combinations of features of the invention result from the following detailed description and the entirety of the patent claims.

### BRIEF DESCRIPTION OF THE DRAWINGS

The drawings used to illustrate the embodiment example show:

FIG. 1 a schematic view of a double-knife cutting system according to the invention,

FIG. 2a schematic sectional view of a mower knife device according to the invention, and

FIG. 3 a perspective view of a mower knife device according to the invention.

In principle, identical parts are marked with identical reference signs in the figures.

### WAYS TO CARRY OUT THE INVENTION

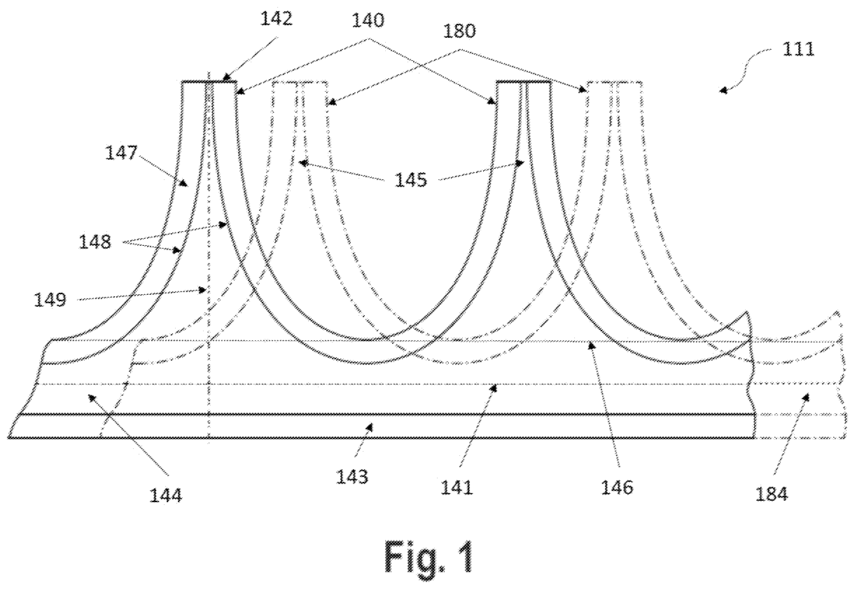

FIG. 1 shows a schematic top view of a double-knife cutting system 111 according to the invention. The double-knife cutting system 111 comprises an upper cutting knife 140 and a lower cutting knife 180, which are configured to be movable in translation relatively to one another. The upper cutting knife 140 and the lower cutting knife 180 each comprise a plurality of blade elements 145, each of which comprises two strictly convex boundaries 148 with cutting edges 147 arranged thereon. The blade elements 145 are each configured symmetrically around a centerline 149, wherein the boundaries 148 near the blade tip 142 or the centerline 149 run approximately parallel to the centerline 149 and form a larger angle to the centerline 149 in an area between two adjacent blade elements 145. The blade elements 145 of the upper cutting knife 140 are interconnected by a knife back 144, and the blade elements 145 of the lower cutting knife 180 are also interconnected by a knife back 184, wherein the knife back 144, 184 extends between a first knife back boundary line 146 and an end surface 143.

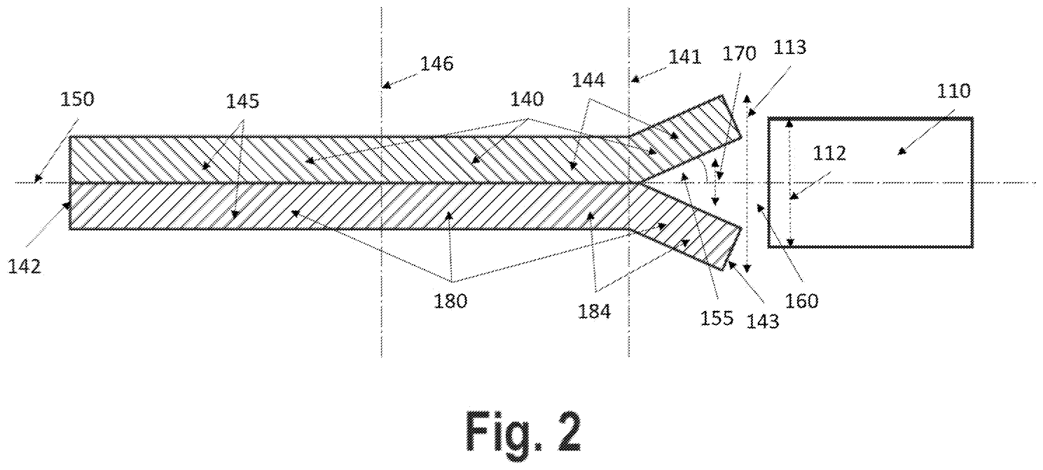

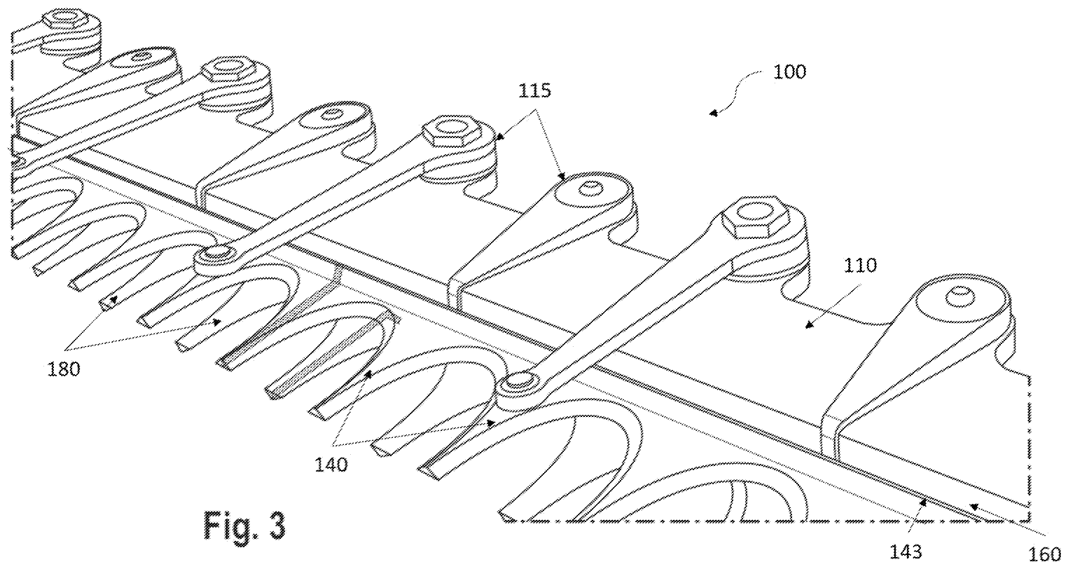

The knife back 144, 184 is bent in a section adjacent to a gap 160 between the double-knife cutting system 111 and a knife bar 110 (shown in FIG. 2 and FIG. 3). The two lower lines shown in

FIG. 1 show a top view of end surfaces 143 of the bent knife back 144, 184, and the line 141 drawn above them schematically shows the beginning of the bent sections of the knife backs 144, 184 of the upper 140 and the lower 180 cutting knife, wherein the latter line 141 may, for example, represent a bending edge at which the knife back 144, 184 is bent. The section of the knife back 144, 184 adjacent to the gap 160 may also be bent by rolling, although other types of bending and forming are also possible.

FIG. 2 shows a schematic sectional view of a mower knife device 100 according to the invention comprising a double-knife cutting system 111 and a knife bar 110, wherein the knife bar 110 is connected to the double-knife cutting system 111 by means of holding devices (not shown). The double-knife cutting system 111 is arranged symmetrically about a knife plane 150; the knife bar 110 is further located at the level of the double-knife cutting system 111. In the direction of an axis 170 orthogonal to the knife plane 150, the knife bar comprises a first extension 112. Sections of the knife back 144, 184 adjacent to a gap 160 between the knife bar 110 and the double-knife cutting system 111 are bent symmetrically in the direction of the orthogonal axis 170 with respect to the knife plane 150. The knife backs 144, 184 shown in FIG. 2 are bent such that a distance 113 between protruding parts of the bent knife backs 144, 184 is greater than the first extension 112 of the knife bar 110: this partially shields the gap 160. The bending of the sections of the knife back 144, 184 adjacent to the gap 160 can also be configured such that the distance 113 is equal to the first extension 112. The bending angle 155 shown in FIG. 2 is to be understood only schematically and can be between 5° and 45° and preferably equal to 15°.

FIG. 3 shows a perspective view of a mower knife device 100 according to the invention, comprising a double-knife cutting system 111, a knife bar 110 and holding devices 115 for connecting the knife bar 110 to the double-knife cutting system 111, wherein a gap 160 is present between the double-knife cutting system 111 and the knife bar 110. As shown schematically in FIG. 3 using the striped areas, the knife back 144 of the upper cutting knife 140 is bent upwardly in a section adjacent to the gap 160 and the knife back 184 of the lower cutting knife 180 is bent downwardly in the section adjacent to the gap 160. The bending of the sections of the knife backs 144, 184 adjacent to the gap 160 is uniform along the entire width of the double-knife cutting system 111.

I claim:

1-12. (canceled)

13. A mower knife device, comprising:
a double-knife cutting system, wherein the double-knife cutting system comprises an upper cutting knife and a lower cutting knife, which are configured to be movable in translation relatively to one another, wherein the upper cutting knife and the lower cutting knife each comprise a plurality of blade elements and a knife back, wherein the blade elements are configured to be connected to one another via the knife back and arranged essentially in a knife plane,
a knife bar which comprises a first extension in the direction of an axis orthogonal to the knife plane and which is configured to hold the double-knife cutting system, wherein a gap is arranged between the knife bar and the double-knife cutting system, wherein a section of the knife back adjoins the gap,
wherein the section of the knife back adjacent to the gap is bent in the direction of the orthogonal axis.

14. The mower knife device according to claim 13, wherein the knife bar is arranged at the level of the double-knife cutting system, in particular symmetrically around the knife plane, and/or wherein the section of the knife back of the upper cutting knife adjacent to the gap and the section of the knife back of the lower cutting knife adjacent to the gap are bent substantially symmetrically with respect to the knife plane.

15. The mower knife device according to claim 13, wherein the section of the knife back adjacent to the gap is bent along an entire width of the double-knife cutting system, in particular uniformly.

16. The mower knife device according to claim 13, wherein the section of the knife back adjacent to the gap is bent such that a distance between a projecting part of the bent knife back of the upper cutting knife and a projecting part of the bent knife back of the lower cutting knife in the direction of the orthogonal axis corresponds to at least the first extension of the knife bar.

17. The mower knife device according to claim 13, wherein the bent section of the knife back is flat and comprises a bending angle of between 5° and 45°, preferably 15°, relative to the knife plane.

18. The mower knife device according to claim 13, wherein each blade element comprises two strictly convexly formed boundaries with cutting edges arranged thereon, wherein the cutting edge of one blade element and the opposite cutting edge of an adjacent blade element extend continuously over the knife back.

19. The mower knife device according to claim 18, wherein each blade element is symmetrically constructed around a centerline which runs parallel to a direction from a blade tip of the blade element to the knife bar, wherein the two strictly convexly formed boundaries in the region of the blade tip run substantially parallel to the centerline.

20. The mower knife device according to claim 18, wherein the cutting edges are flat.

21. The mower knife device according to claim 13, comprising a knife head to initiate a drive movement of a lateral drive on the double-knife cutting system, wherein the knife head is fixedly connected directly to the upper cutting knife at a remaining section, which comprises sections of the knife back located outside the bent section of the knife back, and in particular is fixedly connected without additional reinforcement.

22. The mower knife device according to claim 13, wherein the knife back comprises an extension of at least 10 mm, preferably 33 mm, in the direction from a blade tip of the blade element to the knife bar, wherein the bent section of the knife back comprises an extension of at least 5 mm, preferably half of the extension of the knife back, in the direction from a blade tip of the blade element to the knife bar.

23. The mower knife device according to claim 13, wherein the upper cutting knife and/or the lower cutting knife is formed in one piece, in particular made of a flat steel and subsequently bent.

24. The mower knife device according to claim 13, wherein the remaining sections of the upper cutting knife and of the lower cutting knife are formed substantially flat outside the bent sections of the knife back.
